(19) United States
(12) Patent Application Publication
(10) Pub. No.: US 2012/0282868 A1
(43) Pub. Date: Nov. 8, 2012

(54) Pyramidal Antenna Apparatus

(75) Inventor: Philip Hahn, Berwick, ME (US)

(73) Assignee: OMNI-WiFi, LLC, Berwick, ME (US)

(21) Appl. No.: 13/464,130

(22) Filed: May 4, 2012

Related U.S. Application Data
(60) Provisional application No. 61/482,750, filed on May 5, 2011.

(51) Int. Cl. H04B 1/38

(52) U.S. Cl. 455/90.3

(57) ABSTRACT

A wireless communication apparatus includes a radio transceiver, multiple antenna elements coupled to respective planar portions of a pyramidal frame, and a bi-directional radio frequency (RF) amplifier. The transceiver may be configured to transmit and receive radio frequency signals. In combination, the antenna elements may be configured to direct radio frequency signals to and from the radio transceiver, e.g., omnidirectionally. The amplifier may be configured to amplify radio frequency signals received via the antenna elements and radio frequency signals to be transmitted via the antenna elements.

### PRIORITY CLAIM

This application claims priority under 35 U.S.C. §119(e) from U.S. Provisional Pat. Ser. No. 61/482,750 entitled “Pyramidal Antenna with Weather-Tight Enclosure” filed May 5, 2011, the entirety of which is hereby incorporated by reference herein.

### BACKGROUND

Wireless networking is becoming increasingly prevalent in a variety of contexts. People commonly use wireless communication technologies such as Wi-Fi to connect various devices, e.g., personal computers or mobile devices, to network resources such as the Internet without the inconvenience factor of wires. Such devices may connect to a wireless access point or hotspot through the use of a router connected to a link to an Internet service provider. Whether a wireless access point is used in a home or in another location, antenna design is an important consideration that affects the performance of wireless communication.

### SUMMARY

In an embodiment of the present disclosure, a wireless communication apparatus includes a radio transceiver, multiple antenna elements coupled to respective planar portions of a pyramidal frame, and a bi-directional radio frequency (RF) amplifier. The transceiver may be configured to transmit and receive radio frequency signals. In combination, the antenna elements may be configured to direct radio frequency signals to and from the radio transceiver, e.g., omnidirectionally. The amplifier may be configured to amplify radio frequency signals received via the antenna elements and radio frequency signals to be transmitted via the antenna elements.

In some embodiments, a wireless communication apparatus includes a radio transceiver, multiple antenna elements arranged uniformly around a central axis, and a bi-directional RF amplifier. The transceiver may be transceiver configured to transmit and receive radio frequency signals. In combination, the antenna elements may be configured to direct radio frequency signals omnidirectionally to and from the radio transceiver. The amplifier may be configured to amplify radio frequency signals received via the antenna elements by a first gain and amplify radio frequency signals to be transmitted via the antenna elements by a second gain. The first gain may be greater than the second gain, and a maximum value of the second gain may be a function of at least a maximum transmit power limit.

In some embodiments, a wireless communication apparatus includes a radio transceiver, multiple antenna elements coupled to respective faces of a pyramidal frame, a bi-directional radio frequency amplifier, a power-over-ethernet (PoE) extractor, and a unitary pyramidal housing. The transceiver may be transceiver configured to transmit and receive radio frequency signals. The antenna elements may be configured to direct radio frequency signals to and from the radio transceiver. The amplifier may be configured to amplify radio frequency signals received via the antenna elements by a first gain and amplify radio frequency signals to be transmitted via the antenna elements by a second gain. The first gain may be greater than the second gain, and a maximum value of the second gain may be a function of at least a maximum transmit power limit. The PoE extractor may include logic configured to protect the amplifier from accidental voltage spikes on oncoming signal pairs. The radio transceiver, the antenna elements, the amplifier, and the PoE extractor may be contained within the housing.

### BRIEF DESCRIPTION OF THE DRAWINGS

The following will be apparent from elements of the figures, which are provided for illustrative purposes and are not necessarily to scale.

FIG. 1 is a perspective view of an antenna in accordance with some embodiments of the present disclosure, showing antenna elements coupled to a pyramidal frame.

FIG. 2 is a perspective view of an antenna in accordance with some embodiments of the present disclosure, showing antenna elements shaped to conform to faces of a pyramidal frame.

FIG. 3 is a perspective view of an antenna in accordance with some embodiments, showing a housing enclosing internal components.

FIG. 4 is a perspective view of a pyramidal antenna in accordance with some embodiments, showing a housing and external interface for connecting cables.

FIG. 5 is a block diagram of an apparatus in accordance with some embodiments.

FIG. 6 is a depiction of a circuit board having a PoE module integrated with an amplifier in accordance with some embodiments.

FIG. 7 is an exemplary radiation pattern diagram for an antenna in accordance with some embodiments.

FIG. 8 is a bottom view of a housing in accordance with some embodiments.

### DETAILED DESCRIPTION

This description of certain exemplary embodiments is intended to be read in connection with the accompanying drawings, which are to be considered part of the entire written description.

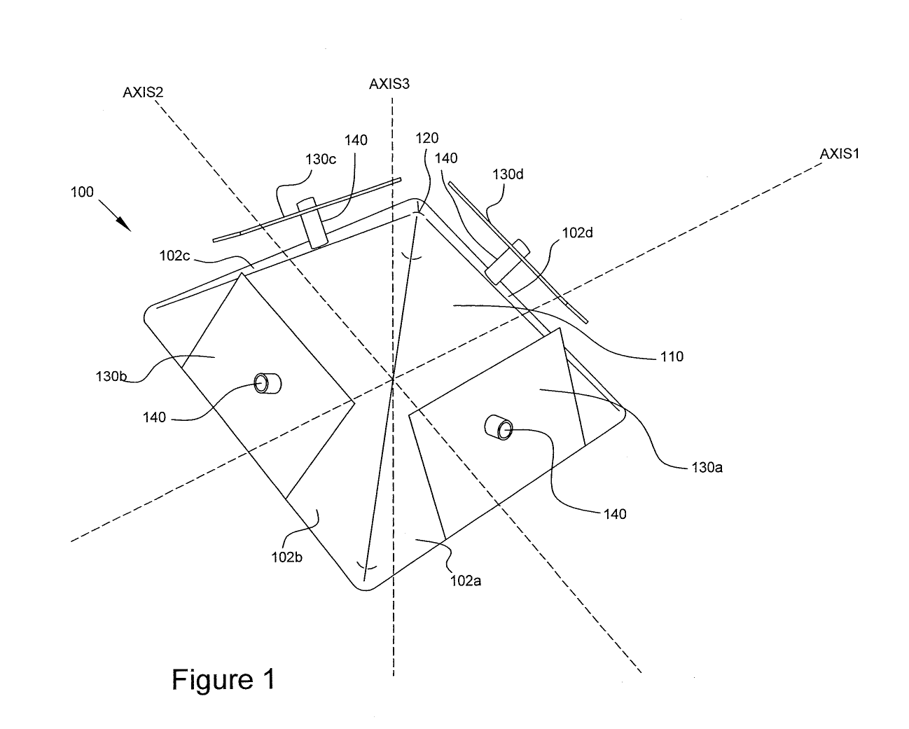

Some embodiments of the present disclosure comprise a novel antenna and enclosing case, which may have a pyramidal shape. FIG. 1 is a perspective view of an antenna apparatus 100 in accordance with some embodiments. In the example of FIG. 1, antenna elements 130a, 130b, 130c, 130d (collectively antenna elements 130) are coupled to a pyramidal frame 110. Antenna elements may be secured to faces of the frame by standoffs 140, which may include bolts, screws, or other fasteners. For example, antenna elements may be secured by the standoffs to a backplane (e.g., a pyramidal backplane) formed from aluminum that is, in one embodiment, about 5″ in length by 5″ in width by 4″ in height. In some embodiments, the backplane forms both a frame and an electrical ground plane component of the antenna. The standoffs 140 may each be about 0.5″ in height and 0.25″ in diameter, thus securing the antenna elements 130 at a distance of about 0.5″ from the backplane at every point on each antenna element for high passive RF gain when transmitting and receiving. Other dimensions for the backplane and standoffs are also contemplated consistent with the scope of the disclosure.

In the example of FIG. 1 employing a square pyramidal design, four antenna elements are arranged in two opposing pairs of antenna elements aligned on respective perpendicular axes AXIS1, AXIS2, with the antenna elements arranged uniformly about a central axis AXIS3 of the pyramid. The vertex 120 of the pyramid is located on the central axis AXIS3, which is normal to the base of the pyramid. In other examples, various numbers of antenna elements may be used, and they may be coupled to a frame that has a triangular base (so that the frame is a triangular pyramid), a hexagonal base, or a base having another shape.

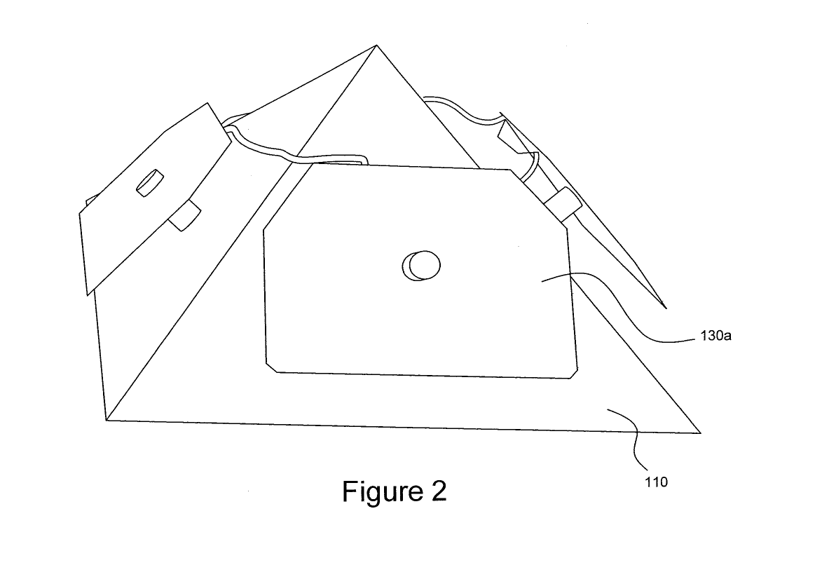

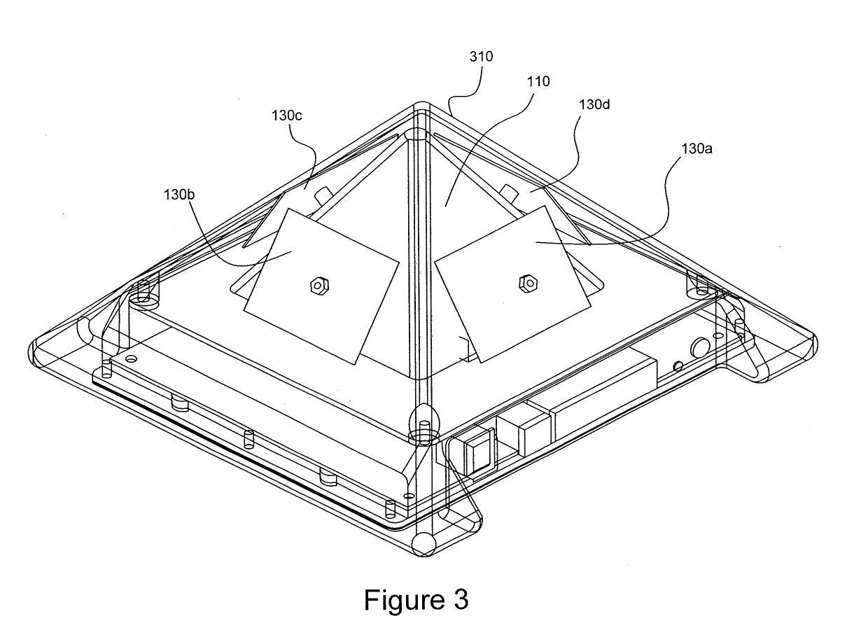

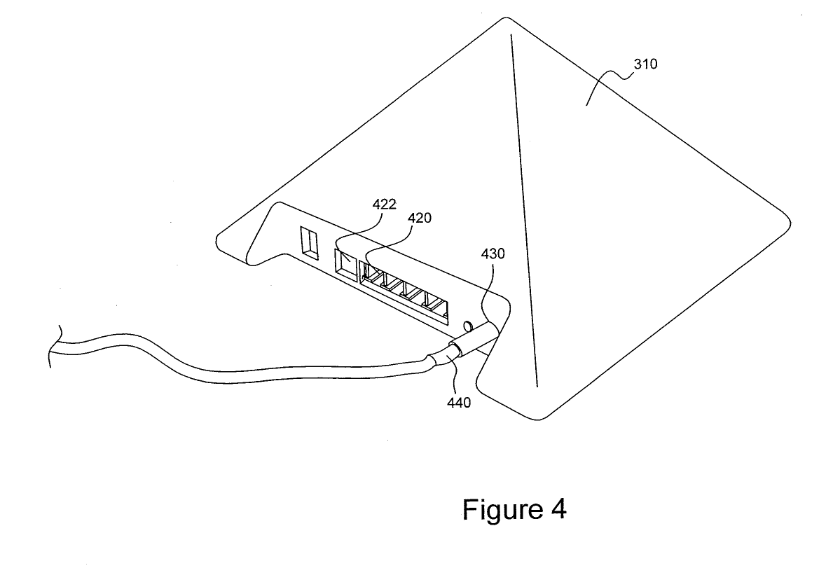

The antenna elements 130 may be formed from aluminum and may each be about 1.75″ by 2.5″ in dimension, although other sizes are contemplated within the scope of the disclosure. The antenna elements may be rectangular as in FIG. 1 or may have another shape, e.g., with one or more corners of a rectangle cut away as in FIG. 2 to conform to a pyramidal face. Thus, the size and shape of the antenna elements and frame may promote efficient use of space, which results in a compact antenna unit. Positioning the antenna elements on respective faces 102a, 102b, 102c, 102d of a pyramidal frame as in FIGS. 1 and 2 enables outward radiation in different directions. The pyramid panel antenna 100 may radiate omnidirectionally, unlike most panel antennas which radiate directionally. FIG. 3 shows antenna apparatus 100 with a surrounding housing 310, which is discussed in more detail below in the context of FIG. 4.

Referring to FIG. 4, a unitary, pyramid-shaped housing 310 is shown which may enclose various components, including a WiFi wireless access point radio transceiver, the antenna elements, a bi-directional amplifier, and related supporting electronics that may be located under the antenna backplane or in another convenient location. The housing (case) may be a weatherproof case for indoor or outdoor use, or may not be weatherproof, e.g., for indoor use. For certain exemplary embodiments employing a square pyramidal base, the base of the square pyramidal case 310 may be about 7″×7″, and the height may be about 5″, although the case dimensions may differ within the scope of the disclosure. The case (enclosure) conceals the antenna and/or the radio and/or related supporting electronics. In some embodiments the case protects the antenna and/or the radio and/or related supporting electronics against environmental factors. The compact design and omnidirectional radiation provide high versatility and functionality in many scenarios, including home WiFi contexts, WiFi service on boats, such as pleasure yachts, or for use in office spaces, auditoria, and similar-sized spaces. In an embodiment with a weatherproof and/or watertight casing, all electrical connections to the electronics internal to the casing pass through the casing through a single watertight connection port. In an embodiment without a weatherproof and/or watertight casing, there may be multiple (e.g., four) LAN ports 420 and a WAN port 422. The case (housing) may also define an opening 430 for connecting an electrical cord or cable 440 to an electrical component within the case. A watertight seal may be provided along the periphery of the opening.

In an embodiment having an antenna with an internal backplane configured as a pyramid (square or otherwise), the surface area of the backplane may be >50% of the surface area of a similar antenna having an internal backplane configured as a bent plate while the pyramidal backplane can either transmit or receive with only a 10% degradation in signal strength and/or RF energy transmitted/received.

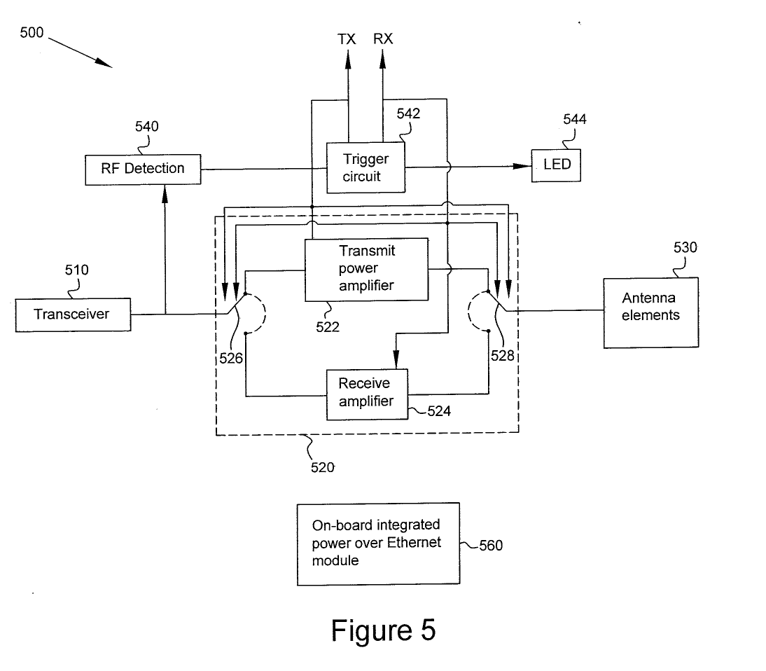

Referring to FIG. 5, in some embodiments a bi-directional radio frequency amplifier 520 is operationally interposed between radio transceiver 510 and antenna elements 530. The bi-directional radio frequency amplifier 520 serves two purposes: a) it comprises a filter used to prevent band-edge transmissions from propagating into upper and lower frequencies adjacent to the frequency currently in use; and b) it amplifies received radio frequency signals to a greater extent than it amplifies radio frequency signals transmitted from the radio transceiver 510. In other words, the bi-directional radio frequency amplifier 510 has the characteristic of reverse gain factor that greatly exceeds the forward gain factor. The forward gain is limited by FCC rules and regulations, but there is no such limitation on reverse gain. By amplifying reverse gain, the client radio frequency signal level is increased to a point comparable to the radio frequency signal level broadcasting from the radio transceiver 510, and a forward-reverse signal balance level is achieved. This can be viewed as send-receive balance or balanced input-output at the radio transceiver 510 output location.

The use of the bi-directional radio frequency amplifier 520 has two advantages: a) the balanced radio transceiver input-output increases the speed at which the radio portion of the communication can occur; and b) it increases the sensitivity of radio transceiver 510 to the received client signal by adding up to 22 dB gain to these generally very weak client signals as they enter the radio transceiver 510. Radio frequency signal level loss caused by the use of the bi-directional radio frequency amplifier 520 is about 8 dB in some embodiments. Therefore, a forward gain of about 15 dB may be generated in the bi-directional radio frequency amplifier 520 to compensate for this loss. The overall output power does not measurably change when compared to a non-amplified device, thereby allowing the amplified device to retain its output power-related FCC certification, e.g., at a frequency of 2.4 GHz. This gain property has been validated by an FCC testing lab. In all cases, the receive gain is increased by at least 22 dB at the bi-directional amplifier, and is increased by at least 1,500 mW net gain total by combination of amplifier and antenna gain, also accounting for cable and amplifier insertion loss of up to 8 dB. Conventional amplifiers at other frequencies do not the variably attenuated transmit signal attenuation provided by various embodiments of the present disclosure, because transmit output power allowed by the FCC for commercial frequencies (e.g., other than 2.4 GHz) is much greater the output power allowed for 2.4 GHz.

Referring again to FIG. 5, a radio transceiver 510 is configured to transmit and receive radio frequency signals. An RF detection module 540 detects an RF input signal. If there is a signal at the input (from the transceiver), detection module 540 asserts a signal (e.g., a voltage signal) to trigger circuit 542. Trigger circuit 542 generates transmit and receive control signals (e.g., voltage signals denoted TX and RX in FIG. 5) which, when asserted, turn on a transmit amplifier 522 and a receive amplifier 524, respectively, of bi-directional amplifier 520. If RF detection module 540 fails to detect an RF input signal, amplifier 520 remains in receive mode.

The transmit power amplifier 522 may include one or more amplifiers. The signal TX that turns on the transmit power amplifier 522 is high (e.g. 5, 8, or 12 V, depending on implementation) when an RF input signal is detected. The receive amplifier 524 may include a low noise amplifier (LNA) followed by a bandpass filter. The signal RX that turns on the receiver amplifier 524 is high (e.g., 5, 8, or 12 V, depending on implementation) when an RF input signal is not detected. An LED 544 may be controlled by trigger circuit 542 to indicate the state of apparatus 500. For example, LED 544 may be controlled to emit red when the amplifier 520 is in receive mode and green when the amplifier is in transmit mode. Switches 526 and 528 selectively couple the transceiver 510 and antenna elements 530 to the transmit amplifier 522 or to the receive amplifier 524. A transmit side switch 526 and a receive side switch 528 may each be implemented as single pole double throw (SPDT) switches. When signal TX is high, the antenna elements are connected to the transmit amplifier 522; when signal RX is high, the antenna elements are connected to the receive amplifier 524.

The circuitry of apparatus 500 may also include a power-over-Ethernet (PoE) extractor 560, e.g., a power adapter suitably adapted to provide PoE functionality, and a power module. The power module includes voltage regulators to generate the relevant voltages for various circuit components. The PoE module 560 may include logic configured to protect the bi-directional amplifier 520 from accidental voltage spikes on oncoming signal pairs. The PoE module 560 may be part of the same circuit board as the amplifier 520, thus integrated with the amplifier as an integral unit. Conventional amplifiers are not integrated with logic-driven signal/voltage PoE extractors. In some embodiments, the PoE extractor 560 operates on input voltages ranging from 6 V to 60 V DC. An incoming voltage surge may be as high as 300 V, producing 60 V out of the ordinarily 12 V power supply to the radio component, and the PoE extractor 560 outputs the correct voltage for the amplifier 520, i.e., about 6 V in some embodiments.

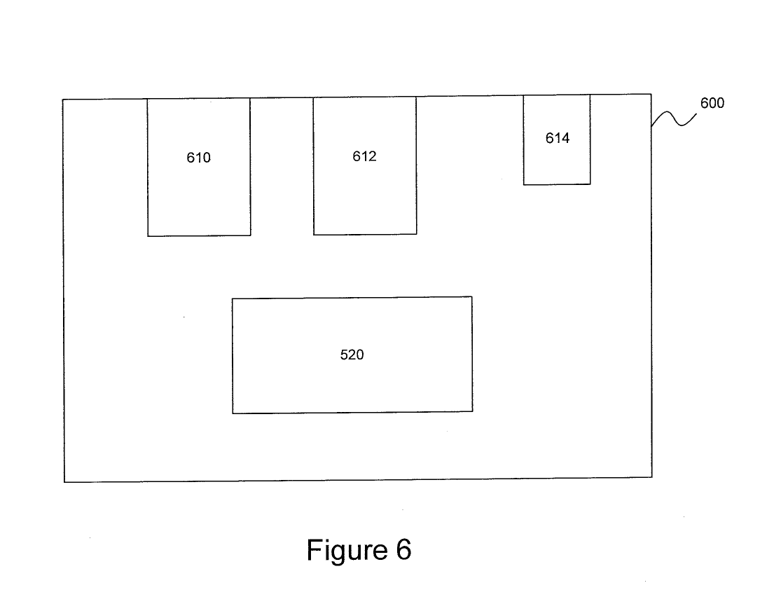

FIG. 6 is a depiction of a circuit board 600 having a PoE module integrated with amplifier 520. The power input for the PoE module may be through an Ethernet connector or through a power jack, as shown in FIG. 6. Ethernet input sockets 610 and 612 support 6 to 60 V DC power and Ethernet signal input. Either Ethernet socket may be used. If only one Ethernet socket is used, the other socket may be used to provide power over Ethernet to another amplifier or another device if needed. Each Ethernet socket may have eight pins. Pins <1, 2> and <3, 6> may be for Ethernet signal pairs. Pins 4-5 may be for positive DC voltage input, and pins 7-8 may be for negative DC voltage input. A standard power socket (jack) 614 supports a 6 V DC power input if power over Ethernet is not used.

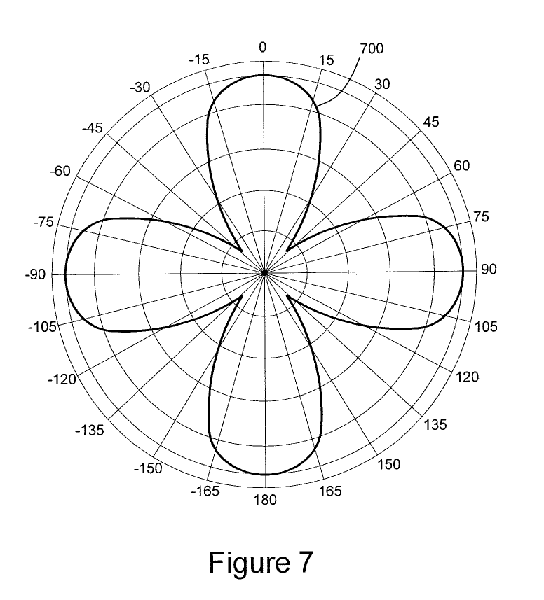

FIG. 7 is an exemplary radiation pattern diagram for antenna apparatus 100 at 2450 MHz. Plot 700 shows uniform lobes radiating from each side of the pyramidal antenna. FIG. 7 shows that various embodiments of the present disclosure provide omnidirectional radiation in contrast to directional radiation of conventional panel antennas. In some embodiments, the sensitivity of the pyramidal panel antenna is eight times greater than that of an omnidirectional mast antenna. The output power of the pyramidal panel antenna may be about 8 to 12 dBi, which is about twice the power of a mast antenna of equal length.

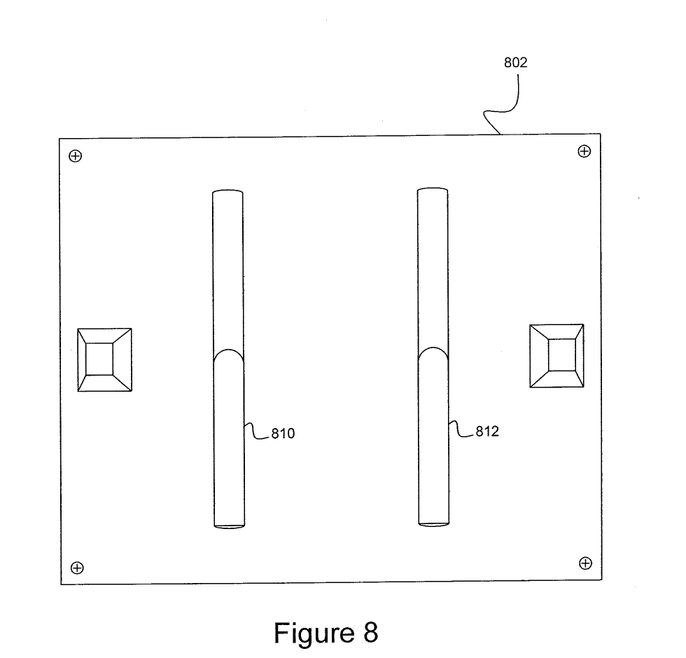

FIG. 8 is a bottom view of housing 310 in accordance with some embodiments. Antennas 810 and 812 are configured for short range broadcast and reception and are secured to an underside 802 of housing 310. Antennas 810 and/or 812 may be provided for multiple-input multiple-output (MIMO) compliance regarding the 802.11n standard. Thus, in some embodiments two or three antennas (a pyramidal antenna including antenna elements 130, and antennas 810 and/or 812) are provided. Antennas 810 and 812 may be coupled to trigger circuit 542 of FIG. 5, with each antenna being used for both transmission and reception, or antennas 810 and 812 may be coupled to amplifier 520.

While examples of various embodiments have been described, it is to be understood that the embodiments described are illustrative only and that the scope of the invention is to be defined solely by the appended claims when accorded a full range of equivalence, many variations and modifications naturally occurring to those of skill in the art from a perusal hereof. For example, in some embodiments optical to electrical conversion may occur before splitting in the processing chain.

What is claimed is:

1. A wireless communication apparatus comprising:
a radio transceiver configured to transmit and receive radio frequency signals;
a plurality of antenna elements coupled to respective planar portions of a pyramidal frame, said antenna elements, in combination, configured to direct radio frequency signals to and from the radio transceiver; and
a bi-directional radio frequency amplifier configured to amplify radio frequency signals received via the antenna elements and radio frequency signals to be transmitted via the antenna elements.

2. The wireless communication apparatus of claim 1, wherein said antenna elements, in combination are configured to direct the radio frequency signals omnidirectionally to and from the radio transceiver.

3. The wireless communication apparatus of claim 1, where said frame includes exactly three edges intersecting at a vertex of a pyramid.

4. The wireless communication apparatus of claim 1, where said frame includes four edges intersecting at a vertex of a pyramid.

5. The wireless communication apparatus of claim 1, further comprising a unitary pyramidal housing, wherein the radio transceiver, the antenna elements, and the amplifier are contained within said housing.

6. The wireless communication apparatus of claim 5, wherein said housing is a weather protective housing.

7. The wireless communication apparatus of claim 6, further comprising a watertight port configured to couple an electrical cable to an electrical component within said housing.

8. The wireless communication apparatus of claim 1, wherein:
the bi-directional radio frequency amplifier is configured to amplify radio frequency signals received via the antenna elements by a first gain and amplify radio frequency signals transmitted via the antenna elements by a second gain;
the first gain is greater than the second gain; and
a maximum value of the second gain is a function of at least a maximum transmit power limit.

9. The wireless communication apparatus of claim 8, wherein the second gain is controlled by a communications management system to control transmission power from the wireless communication apparatus in a predetermined frequency band;
said amplifier further comprising a filter configured to mitigate band-edge transmissions from propagating into upper and lower frequencies adjacent to the predetermined frequency band.

10. The wireless communication apparatus of claim 1, further comprising a power-over-ethernet extractor including logic configured to protect the amplifier from accidental voltage spikes on oncoming signal pairs.

11. A wireless communication apparatus comprising:
a radio transceiver configured to transmit and receive radio frequency signals;
a plurality of antenna elements arranged uniformly about a central axis, the antenna elements, in combination, configured to direct radio frequency signals omnidirectionally to and from the radio transceiver; and
a bi-directional radio frequency amplifier configured to amplify radio frequency signals received via the antenna elements by a first gain and amplify radio frequency signals to be transmitted via the antenna elements by a second gain, wherein the first gain is greater than the second gain, and a maximum value of the second gain is a function of at least a maximum transmit power limit.

12. The wireless communication apparatus of claim 11, further comprising a unitary pyramidal housing, wherein the radio transceiver, the antenna elements, and the amplifier are contained within the housing.

13. The wireless communication apparatus of claim 12, wherein said housing is a weather protective housing.

14. The wireless communication apparatus of claim 11, including four antenna elements lying on four respective planes that intersect at a vertex.

15. The wireless communication apparatus of claim 11, wherein the second gain is controlled by a communications management system to control transmission power from the wireless communication apparatus in a predetermined frequency band;
said amplifier further comprising a filter configured to mitigate band-edge transmissions from propagating into upper and lower frequencies adjacent to the predetermined frequency band.

16. The wireless communication apparatus of claim 11, further comprising a power-over-ethernet extractor including logic configured to protect the amplifier from accidental voltage spikes on oncoming signal pairs.

17. A wireless communication apparatus comprising:
a radio transceiver configured to transmit and receive radio frequency signals;
a plurality of antenna elements coupled to respective faces of a pyramidal frame, said antenna elements configured to direct radio frequency signals to and from the radio transceiver;
a bi-directional radio frequency amplifier configured to amplify radio frequency signals received via the antenna elements by a first gain and amplify radio frequency signals to be transmitted via the antenna elements by a second gain, wherein the first gain is greater than the second gain, and a maximum value of the second gain is a function of at least a maximum transmit power limit;
a power-over-ethernet (PoE) extractor including logic configured to protect the amplifier from accidental voltage spikes on oncoming signal pairs; and
a unitary pyramidal housing, wherein the radio transceiver, the antenna elements, the amplifier, and the PoE extractor are contained within the housing.

18. The wireless communication apparatus of claim 17, wherein the PoE extractor is integrated with said amplifier.

19. The wireless communication apparatus of claim 17, further comprising a watertight port configured to couple an electrical cable to an electrical component within said housing.

20. The wireless communication apparatus of claim 17, wherein the second gain is controlled by a communications management system to control transmission power from the wireless communication apparatus in a predetermined frequency band;
said amplifier further comprising a filter configured to mitigate band-edge transmissions from propagating into upper and lower frequencies adjacent to the predetermined frequency band.

21. The wireless communication apparatus of claim 17, wherein said housing is a weather protective housing.
